(19) United States
(12) Patent Application Publication
(10) Pub. No.: US 2008/0150375 A1
(43) Pub. Date: Jun. 26, 2008

(54) Electric power tool

(75) Inventor: Kensuke Shima, Osaka (JP)

Correspondence Address: HESLIN ROTHENBERG FARLEY & MESITI PC, 5 COLUMBIA CIRCLE, ALBANY, NY, 12203, US

(73) Assignee: Jefcom Co., Ltd., Osaka (JP)

(21) Appl. No.: 11/459,478

(22) Filed: Jul. 24, 2006

(30) Foreign Application Priority Data
Jul. 26, 2005 (JP) 2005-216330

(51) Int. Cl. H02K 9/06; H02K 7/14

(52) U.S. Cl. 310/50; 310/64; 310/60 R

(57) ABSTRACT

An electric power tool includes a tool body having a rotor, an inner cylindrical body and outer cylindrical body. The rotor is provided with a ventilation space therearound, a body part and a brush contact part, and housed in the inner cylindrical body. The inner cylindrical body is inserted in the outer cylindrical body which has a plurality of groove-like ventilation spaces on its inner face. The rotation of a fan fitted on the rotor circulates air within the tool body through the ventilation spaces so as to cool down the body part and the brush contact part of the rotor. The electric power tool has the rotor with which not only the body part but also other heated parts are fully cooled down. The electric power tool enhances heat dissipation efficiency from a motor case, enables efficient cooling of heated parts and has a long durability.

### BACKGROUND OF THE INVENTION

1. Field of the Invention

The present invention relates to an electric power tool used for cutting and drilling in electric works, building works or the like.

2. Description of the Related Art

Heated parts in an electric power tool of this kind, such as a support bearing, a rotor body, and a brush contact part of a rotor, has been conventionally cooled in such a manner that outside air is introduced from a rear part of the tool by a fan provided within the tool body, applied to the heated part to absorb the heat thereof, and discharged from a front part of the tool. However, depending on the workpieces to be cut or drilled, while they are being cut or drilled, some kinds of cutting powders become powder dust and float therearound. As a result, the powder dust is contained in the outside air introduced into the tool body and adheres to the rotor and other parts to cause the breakdown of the electric power tool.

Thus, a self-cooling motor applicable to this kind of electric power tool, in which an airflow is generated in a motor case by the rotation of a rotor which rotates within a stator and the motor case is cooled using this air flow, has been developed. One example of such a self-cooling motor is disclosed in Japanese Patent No. 3606841 (Pages 1 and 4, and FIG. 5). As shown in FIG. 15, for example, such a self-cooling motor 20 has a stator 21 and a rotor 22 rotating within this stator 21. The rotor 22 has a cylindrical sleeve 23 attached to this rotor 22, and this cylindrical sleeve 23 is provided with a spiral groove 23a on its outer surface to be hermetically fitted to the motor case 24. A gap S is formed between a casing of this self-cooling motor 20 and the motor case 24. The air flow generated between the stator 21 and the rotor 22 circulates as shown by arrows through the gap S so as to entrain the heat generated at the stator 21 to the outer side (the side of the gap S) of the stator 21 along with the rotation of the rotor 22, and discharge it outside of the motor case 24. In the drawing, reference numerals 25 and 26 denote hermetic seal parts, and reference numerals 27 and 28 denote bearings for rotatably supporting the rotor 22.

It is disclosed that this structure prevents the self-cooling motor 20 from entrapment of powder dust from the outside, and that this self-cooling motor 20 is suitable for operation for a long time in a place where a lot of powder dust floats.

However, the foregoing self-cooling motor still has a problem. Although the body of the rotor 22 can be sufficiently cooled by the spiral groove 23a provided on the outer surface of the cylindrical sleeve 23 attached to the rotor 22, heated parts other than the body of the rotor 22, such as bearings 27 and 28 for supporting the rotor 22, the brush contacting part (not shown) cannot be sufficiently cooled.

Further, although the foregoing conventional self-cooling motor is designed to guide the heat generated at the stator 21 to the outer side (the side of the gap S) of the stator 21 along with the rotation of the rotor 22 and discharge the heat outside of the motor case 24, heat dissipation efficiency is rather low and thereby the rotor 22 cannot be efficiently cooled off.

### SUMMARY OF THE INVENTION

It is an object of the present invention to dissolve the foregoing problems and provide an electric power tool which does not take powder dust in from outside. The electric power tool is provided with a rotor sufficiently cooling not only the body part but also other heated parts of the rotor, in which heat dissipation from the motor case is improved and efficient cooling of the heated parts is achieved, and thereby the tool has a long durability.

For this purpose, the electric power tool according to the present invention includes a tool body having a rotor with a ventilation space therearound, a body part and a brush contact part, an inner cylindrical body housing the rotor therein, and an outer cylindrical body in which the inner cylindrical body is inserted and which has a plurality of groove-like ventilation spaces on its inner face. The rotation of a fan fitted on the rotor circulates air within the tool body through the ventilation spaces so as to cool down the body part and the brush contact part of the rotor.

The outer cylindrical body may have a plurality of heat dissipation fins on its outer circumferential face.

The electric power tool according to the present invention includes a tool body having a rotor having a ventilation apace therearound, a body part, a brush contact part, a front bearing part and a rear bearing part, an inner cylindrical body housing the rotor therein, an outer cylindrical body in which the inner cylindrical body is inserted and which has a plurality of groove-like ventilation spaces on its inner face, a front cap attached to and covering the front end of the outer cylindrical body to provide a ventilation space between the front cap and the front end, and a rear cap attached to and covering the rear end of the outer cylindrical body to provide a ventilation space between the rear cap and the rear end. The rotation of a fan fitted to the rotor circulates the air within the tool body so as to cool the body part, the brush contact part, the front bearing part and the rear bearing parts.

The outer cylindrical body may have a plurality of heat dissipation fins on its outer circumferential face.

The electric power tool also has a support part for the front bearing part and a plurality of heat dissipation fin on the front cap, in which the circulating air through the ventilation spaces bumps against the heat dissipation fins, and a support part for the rear bearing part and a plurality of heat dissipation fins on the rear cap, in which the circulating air through the ventilation spaces bumps against the heat dissipation fins.

The electric power tool according to the present invention sucks outside air into the tool body as part of the circulating air, and discharges part of the circulating air outside of the tool body.

Being constructed as stated above, the electric power tool according to the present invention includes a rotor which enables to sufficiently cool not only the body part but also other heated parts of the rotor, and the electric power tool improves heat dissipation efficiency from the motor case, efficiently cools the heated parts, and has a long durability.

### BRIEF DESCRIPTION OF THE DRAWINGS

FIG. 1 is a side view showing an embodiment of an electric power tool according to the present invention.

FIG. 2 is a rear view showing the electric power tool according to the present invention shown in FIG. 1.

FIG. 3 is a sectional view showing the electric power tool according to the present invention shown in FIG. 1.

FIG. 4 is a side view showing another embodiment of an electric power tool according to the present invention.

FIG. 5 is a rear view showing the electric power tool according to the present invention shown in FIG. 4.

FIG. 6 is a sectional view showing the electric power tool according to the present invention shown in FIG. 4.

FIG. 7 is a sectional view taken along line A-A in FIG. 1 and line a-a in FIG. 4.

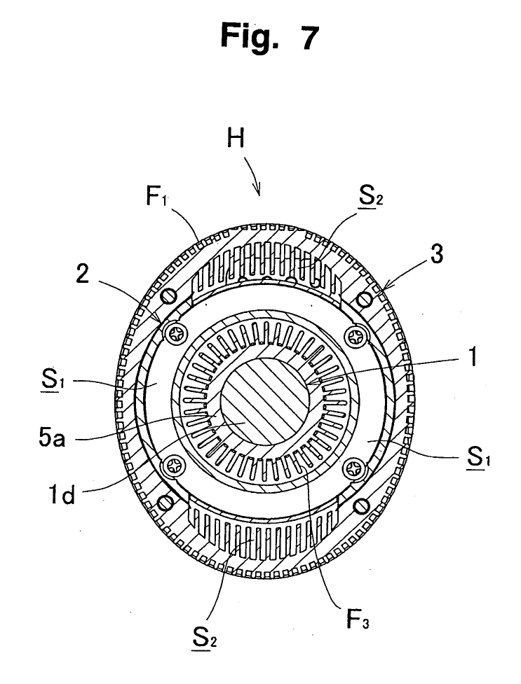

FIG. 8 is a sectional view taken along line B-B in FIG. 1 and line b-b in FIG. 4.

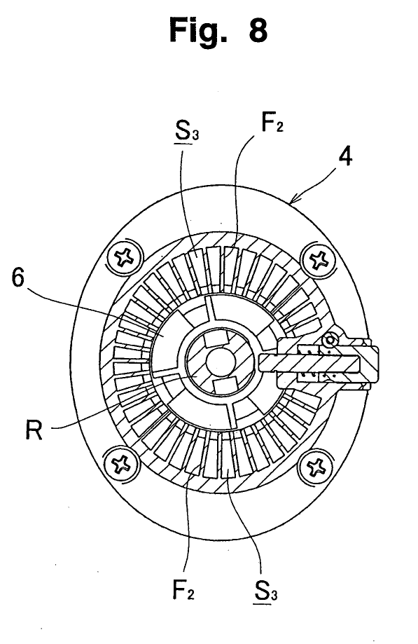

FIG. 9 is a sectional view taken along line C-C in FIG. 1 and line c-c in FIG. 4.

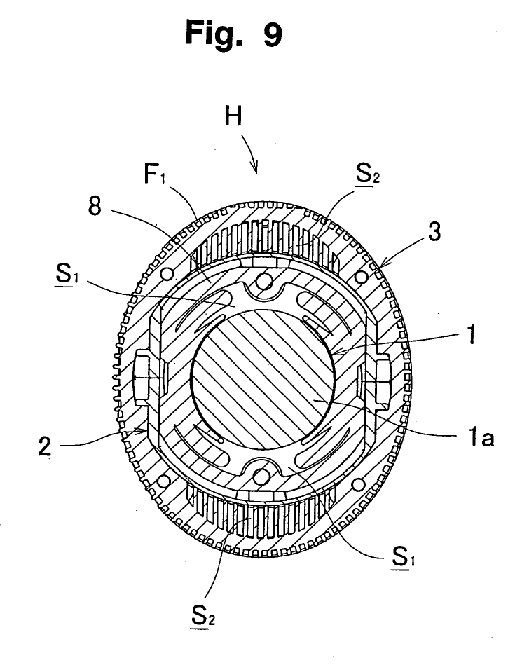

FIG. 10 is a perspective view of a rotor of the electric power tool according to the present invention.

FIG. 11 is a perspective view of a semi cylindrical body forming an inner cylindrical body of the electric power tool according to the present invention.

FIG. 12 is a perspective view of an outer cylindrical body of the electric power tool according to the present invention.

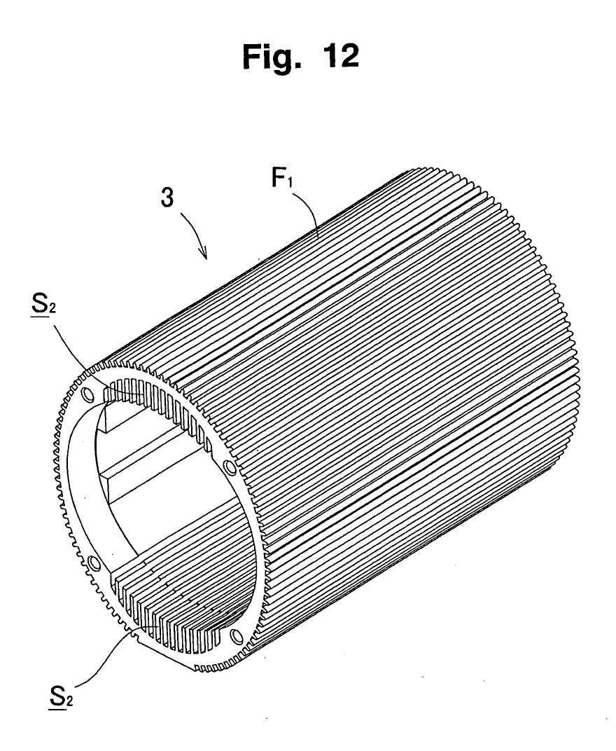

FIG. 13 is a perspective view of a front cap of the electric power tool according to the present invention.

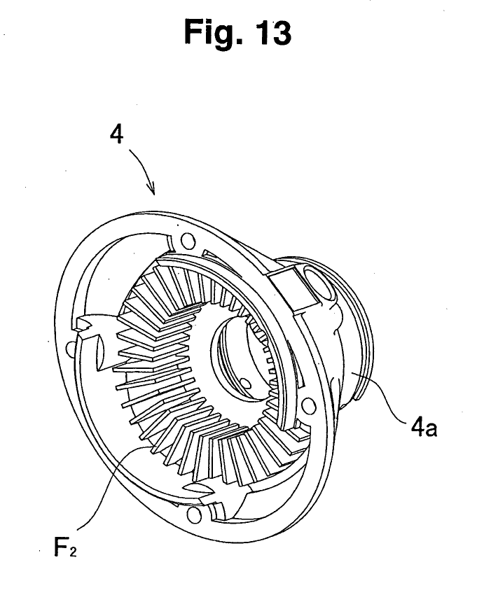

FIG. 14 is a perspective view of a rear cap of the electric power tool according to the present invention.

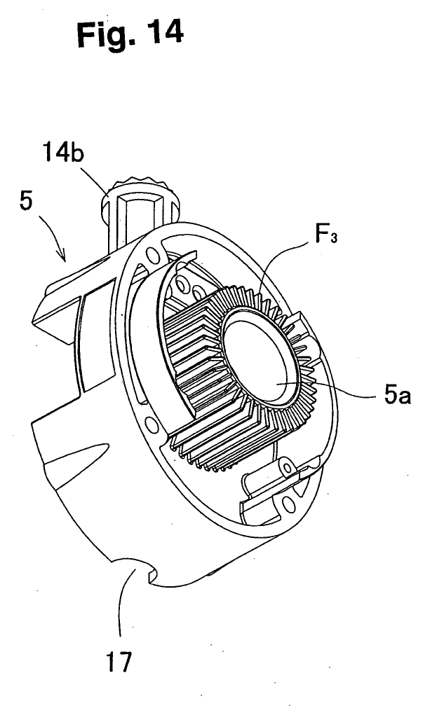

FIG. 15 is a perspective view of a conventional self-cooling motor applicable to an electric power tool.

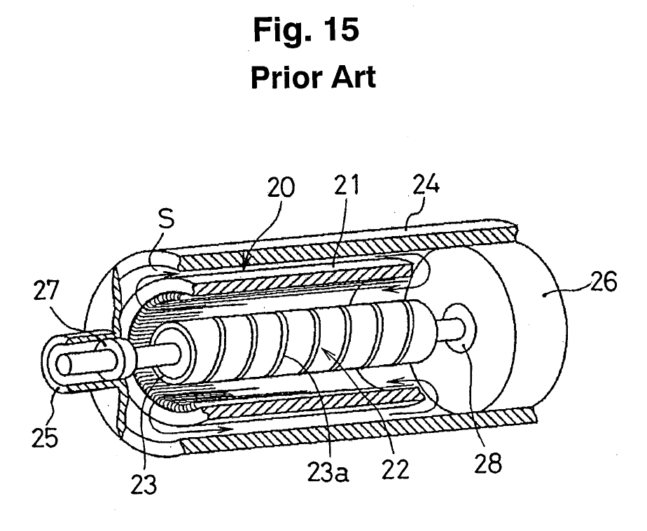

### DETAILED DESCRIPTION OF THE PREFERRED EMBODIMENTS

Preferable embodiments of an electric power tool according to the present invention will be described below in detail with reference to the drawings.

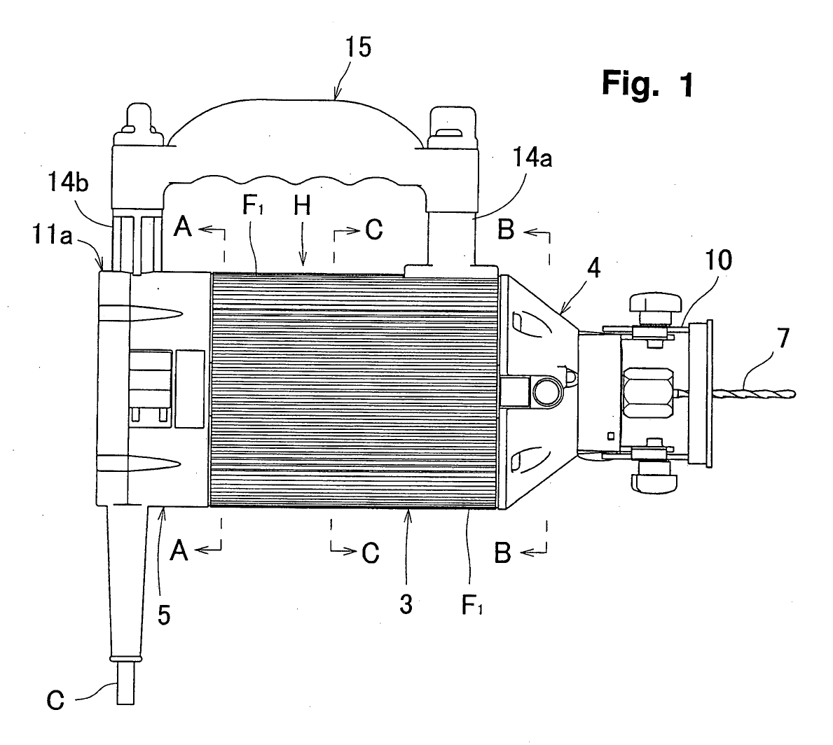

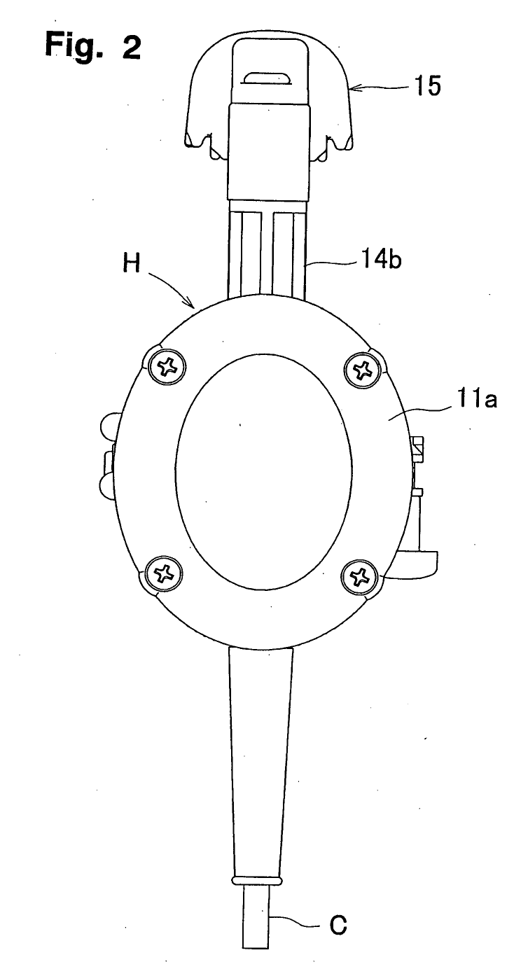

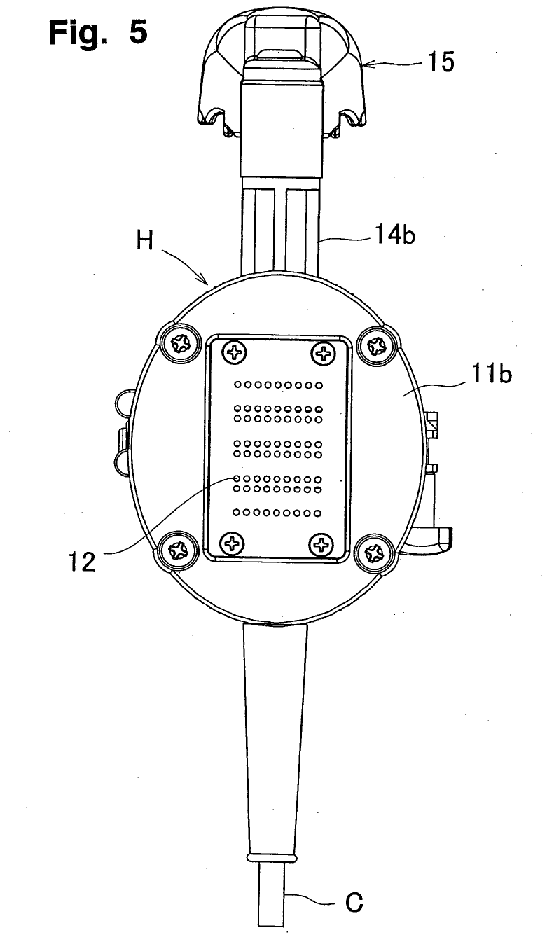

Embodiments are shown in FIGS. 1 to 3 or FIGS. 4 to 6. An electric power tool according to the present invention includes a tool body H having a rotor 1, an inner cylindrical body 2 and an outer cylindrical body 3. The inner cylindrical body 2 houses the rotor 1 with a ventilation space S1 therearound, and is inserted into the outer cylindrical body 3 which has a plurality of groove-shaped ventilation spaces S2 on its upper and lower parts of the inner face and a plurality of heat dissipation fins F1 on its outer circumferential face. The outer cylindrical body 3 has, on its front end, a ventilation space S3 covered with a front cap 4, and, on its rear end, a ventilation space S4 covered with a rear cap 5. In the electric power tool according to the present invention, the rotation of a fan 6 which is attached to the rotor 1 circulates the air in the tool body H through the ventilation spaces S1, S2, S3, and S4 so as to cool a body part 1a, a brush contact part 1b, a front bearing part 1c and a rear bearing part 1d of the rotor 1. The air in the tool body H may be circulated by the rotation of the fan 6 through the ventilation spaces S1 and S2 so as to cool the body part 1a and the brush contact part 1b only. If the outer cylindrical body 3 has a plurality of groove-like ventilation spaces S2 on its upper and lower parts of the inner face, the electric power tool according to the present invention can be carried out without a plurality of heat dissipation fins F1 on its outer circumferential face.

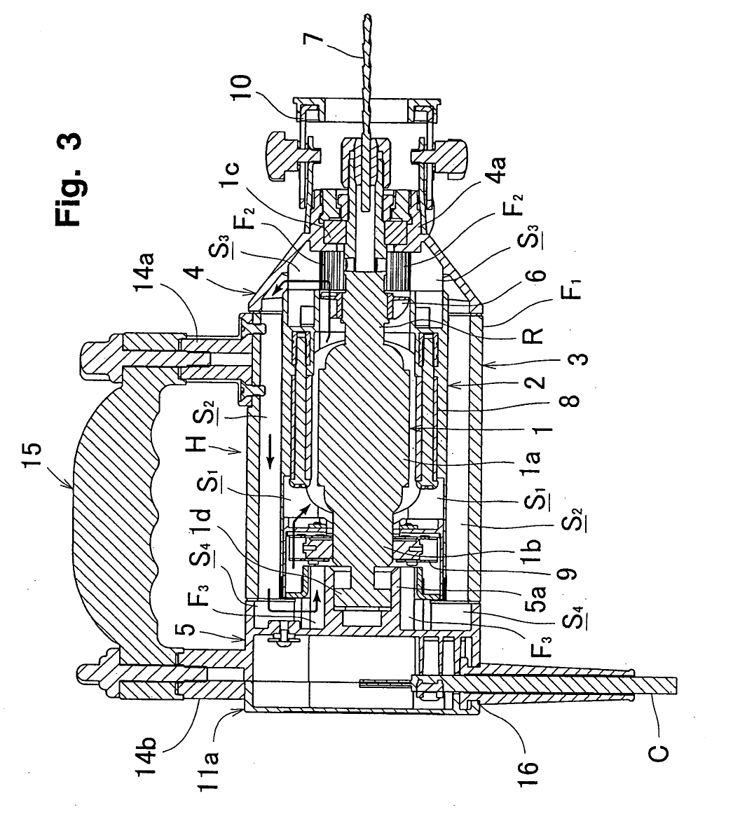

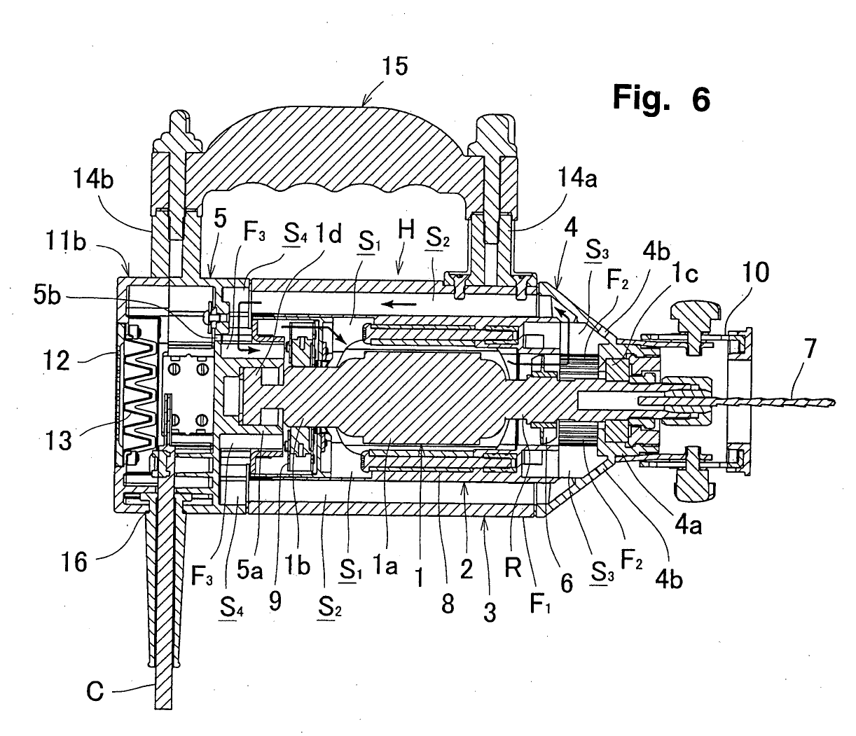

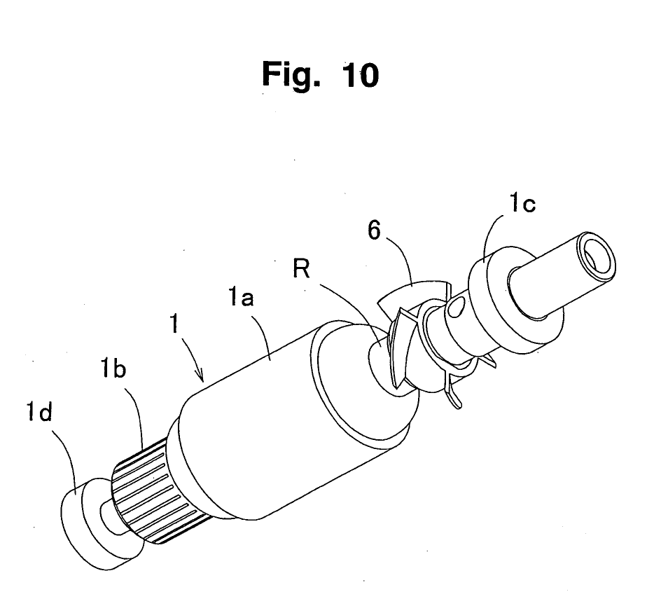

As clearly shown in FIG. 10, the rotor 1 has a rotor shaft R, the body part 1a provided on the shaft R, the fan 6 fitted to the part of the rotor shaft R in front of the body part 1a, the brush contact part 1b fitted to the part of the rotor shaft R in back of the body part 1a, the front bearing part 1c attached to the front part of the rotor shaft R, and the rear bearing part 1d attached to the rear end of the rotor shaft R, and a tool 7 for cutting and drilling is to be mounted on the front end of the rotor shaft R. As clearly shown in FIGS. 3 and 6, the rotor 1 is assembled into the electric power tool in the manner that the body part 1a is disposed on a bobbin 8, the brush contact part 1b is disposed on a brush table 9, the front bearing part 1c is disposed on the front cap 4, and the rear bearing part 1d is disposed on the rear cap 5.

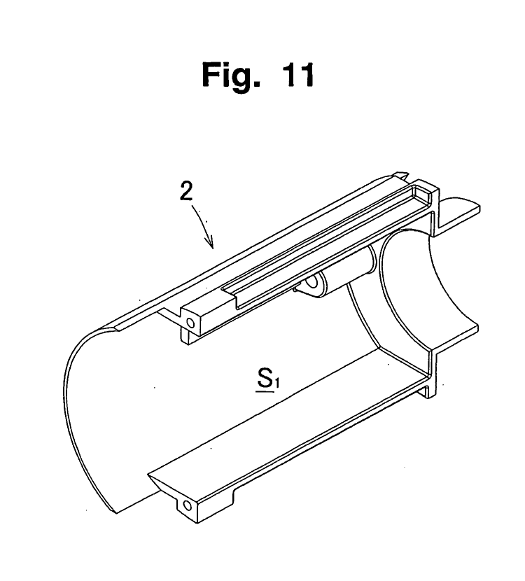

The inner cylindrical body 2 may be made of materials with high heat conductance such as an aluminum alloy. However, in order to decrease the heat conductance to the outer cylindrical body 3, it is rather preferable that the inner cylindrical body 2 is made of materials with low heat conductance such as a synthetic resin. The inner cylindrical body 2 according to the present invention is formed in a cylindrical shape by combining two semi cylindrical bodies as shown in FIG. 11, which holds the bobbin 8 and the brush table 9, and communicates with the ventilation spaces S3 and S4 at its front and rear ends respectively.

The outer cylindrical body 3 may be made of, for example, metal materials or complex materials including a metal and a synthetic resin. However, it is preferable that the outer cylindrical body 3 is made of materials with high heat conductance such as an aluminum alloy. In the cylindrical body 3 of the present invention, the outer circumferential part has an elliptical cylindrical shape, while the inner circumferential part has a cylindrical shape. And, as described above, a plurality of groove-like ventilation spaces S2 are formed on its upper and lower parts of the inner face and a plurality of heat dissipation fins F1 are formed on the other circumferential face. Alternatively, both of the inner and outer circumferential parts may be formed in an elliptical cylindrical shape, or both in a cylindrical shape. The electric power tool with the outer circumferential part in an elliptical cylindrical shape may be easily held and enhances workability while performing cutting and drilling operations. The groove-like ventilation spaces S2, which are formed on the upper and lower parts of the inner faces, may be formed on the right and left parts of the inner face or on the upper, lower, right, and left parts of the entire inner face.

The front cap 4 is made of material with high heat conductance such as an aluminum alloy. The front cap 4 includes a support part 4a for the front bearing part 1c at its front part and a plurality of heat dissipation fins F2 therein. The fins receive the air circulating within the tool body H through the ventilation space S3. Further, if necessary, the front end of this front cap 4 is provided with a guide frame body 10 for cutting and drilling of the tool 7 attached to the front end of the rotor shaft R.

The rear cap 5 is made of material with high heat conductance such as an aluminum alloy. The rear cap 5 has a support part 5a for the rear bearing part 1d at its front part and a plurality of heat dissipation fins F3 on the outer circumference of this support part 5a. The heat dissipation fins 3 receive the air circulating within the tool body H through the ventilation space S4. Further, a seal cap 11a is attached behind the rear cap 5, so as to prevent outside air from being sucked into the tool body H.

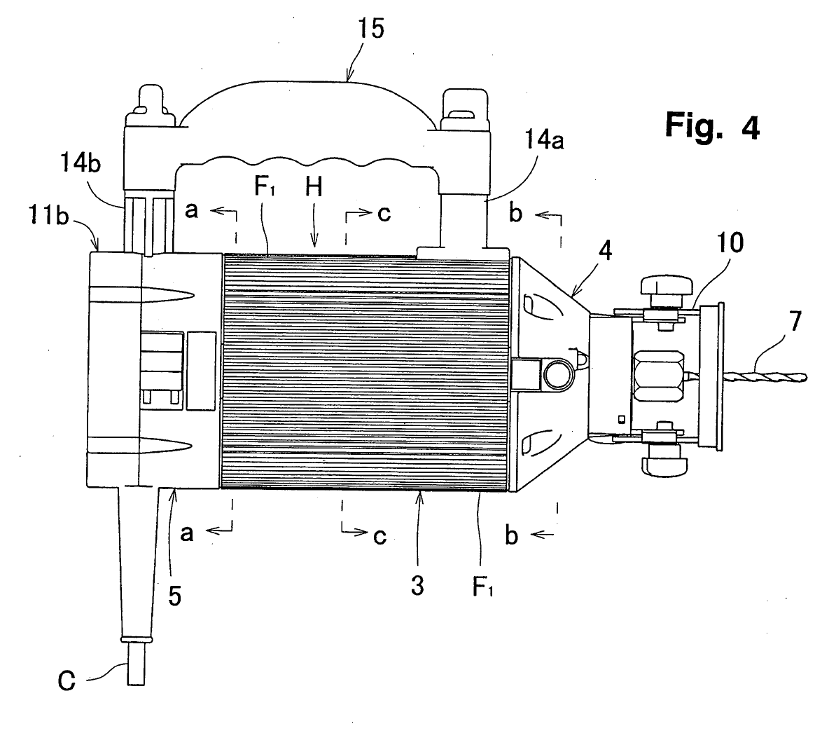

In the embodiment shown in FIGS. 4 to 6, the electric power tool of the present invention sucks outside air into the tool body H and makes it part of the circulating air and discharges part of the circulating air outside of the tool body H. In other words, in place of the seal cap 11a of the foregoing embodiment, the electric power tool includes an incomplete seal cap 11b having a plurality of small ventilating holes and a filter 13. This incomplete seal cap 11b enables to suck outside air to be part of the circulating air (about 5 to 10% of the circulating air) through the ventilating holes 13 and the filter 13. When the incomplete seal cap 11b is attached, an air intake 5b is provided at the rear cap 5 so as to take outside air into the tool body H through this air intake 5b, and an air outlet 4b is provided at the front cap 4 so as to exhaust part of the circulating air through this air outlet 4b.

Further, as shown in the drawings, the electric power tool according to the present invention includes a front engaging part 14a for a handle at the front end of the upper part of the outer cylindrical body 3 and a rear engaging part 14b for the handle is provided at the rear end of the upper part of the rear cap 5. A handle 15 is connected to these engaging parts so as to provide the handle 15 on the tool body H. Furthermore, a boundary between the rear cap 5 and the seal cap 11a or the incomplete seal cap 11b is provided with a penetration hole 16 through which a power code C is brought into the tool body H.

Being constructed as stated above, the electric power tool according to the present invention can cool the body part 1a, the brush contact part 1b, the front bearing part 1c and the rear bearing part 1d of the rotor 1 as follows.

First, in the electric power tool according to the present invention, when the rotor 1 is driven to rotate for performing cutting and drilling operations, the fan 6 attached to this rotor 1 rotates. Then, in the electric power tool according to the embodiment shown in FIGS. 1 to 3, along with the rotation of the fan 6, air within the tool body H flows forward and bumps against the fins F2 provided at the front cap 4 and turns around to the ventilation space S3 and then to the ventilation spaces S2 provided in the outer cylindrical body 3. Subsequently the air further moves through the ventilation space S4, bumps against the fin 3 provided on the rear cap 5, turns around to the ventilation space S1 provided around the rotor 1, reaches the fan 6, and here the air has come full circle. On the other hand, in the electric power tool according to the embodiment shown in FIGS. 4 to 6, along with the rotation of the fan 6, air within the tool body H flows forward and bumps against the fins F2 provided at the front cap 4. Part of the air discharges from the air outlet 4b provided at the front cap 4, and the remaining air turns around to the ventilation space S3 and then the ventilation spaces S2 provided the outer cylindrical body 3. Then, the air further moves through the ventilation space S4, bumps against the fin 3 provided at the rear cap 5 to turn around. Due to a negative pressure generated by the air turning around, outside air is taken in through an air intake 12 of the incomplete seal cap 11b and further sucked into the tool body H through the air intake 5b provided at the rear cap 5. The air newly taken in moves forward together with the air having turned around to the ventilation space S1 around the rotor 1 and then reaches the fan 6, where the air has come full circle.

In both embodiments, during the air circulation through the ventilating spaces within the electric power tool, circulating air comes into contact with the body part 1a, the brush contact part 1b, the front bearing part 1c and the rear bearing part 1d of the rotor 1. Heat generated at the body part 1a and the brush contact part 1b of the rotor 1 may be dissipated into the circulating air, and thereby the body part 1a and the brush contact part 1b are cooled. Heat generated at the front bearing part 1c is conducted to the front cap 4 by which the front bearing part 1c is supported, and efficiently released to the circulating air which bumps against the fins F2 provided at this front cap 4, and thereby the front bearing part 1c can be sufficiently cooled. On the other hand, the heat generated at the rear bearing part 1d is conducted to the rear cap 5 by which the rear bearing part 1d is supported, and efficiently released to the circulating air which bumps against the fins F3 provided at this rear cap 5, and thereby the rear bearing part 1d can be sufficiently cooled.

Then, the heat in the circulating air the temperature of which is increased while cooling the body part 1a, the brush contact part 1b, the front bearing part 1c and the rear bearing part 1d of the rotor 1 is efficiently conducted to the outer cylindrical body 3 while the circulating air passes through a plurality of groove-like ventilation spaces S2 formed on the outer cylindrical body 3, and efficiently dissipated by a plurality of heat dissipation fins F1 formed on the outer circumferential face of this outer cylindrical body 3. Thus, the circulating air can be sufficiently cooled. Further, even if there is no heat dissipation fin F1 on the outer circumferential face of the outer cylindrical body 3, the heat in the circulating air is dissipated from the outer circumferential face of this outer cylindrical body 3 and thereby the circulating air is cooled off.

Further, according to the embodiment shown in FIGS. 4 to 6, in the electric power tool of the present invention, part of the circulating air is discharged through the air outlet 4b at the front cap 4, and outside air is taken in through the air intake 5b at the rear cap 5. Therefore, rise of the temperature of the circulating air can be suppressed compared to the embodiment shown in FIGS. 1 to 3, and the respective heated parts can be more sufficiently cooled.

What is claimed is:

1. An electric power tool having a tool body comprising:
a rotor having a ventilation space therearound, a body part and a brush contact part;
an inner cylindrical body housing the rotor therein;
an outer cylindrical body in which the inner cylindrical body is inserted and which has a plurality of groove-like ventilation spaces on its inner face; and
wherein rotation of a fan fitted on the rotor circulates air within the tool body through the ventilation spaces so as to cool down the body part and the brush contact part.

2. The electric power tool according to claim 1 wherein the outer cylindrical body has a plurality of heat dissipation fins on its outer circumferential face.

3. An electric power tool having a tool body comprising:
a rotor having a ventilation apace therearound, a body part, a brush contact part, a front bearing part and a rear bearing part;
an inner cylindrical body housing the rotor therein;
an outer cylindrical body in which the inner cylindrical body is inserted and which has a plurality of groove-like ventilation spaces on its inner face;
a front cap attached to and covering a front end of the outer cylindrical body with a ventilation space between the front cap and the front end;
a rear cap attached to and covering a rear end of the outer cylindrical body with a ventilation space between the rear cap and the rear end; and
wherein rotation of a fan fitted to the rotor circulates air within the tool body so as to cool the body part, the brush contact part, the front bearing part and the rear bearing part.

4. The electric power tool according to claim 3 wherein the outer cylindrical body has a plurality of heat dissipation fins on its outer circumferential face.

5. The electric power tool according to claim 3 wherein the front cap has a support for the front bearing part and a plurality of heat dissipation fins, against which circulating air bumps, and the rear cap has a support for the rear bearing part and a plurality of heat dissipation fins, against which circulating air bumps.

6. The electric power tool according to claim 4 wherein the front cap has a support for the front bearing part and a plurality of heat dissipation fins, against which circulating air bumps, and the rear cap has a support for the rear bearing part and a plurality of heat dissipation fins, against which circulating air bumps.

7. The electric power tool according to claim 3 wherein, during operation, outside air is taken in within the tool body as part of the circulating air while part of the circulating air is discharged outside.

8. The electric power tool according to claim 4 wherein, during operation, outside air is taken in within the tool body as part of the circulating air while part of the circulating air is discharged outside.

9. The electric power tool according to claim 5 wherein, during operation, outside air is taken in within the tool body as part of the circulating air while part of the circulating air is discharged outside.

10. The electric power tool according to claim 6 wherein, during operation, outside air is taken in within the tool body as part of the circulating air while part of the circulating air is discharged outside.
